(19) United States
(12) Patent Application Publication
(10) Pub. No.: US 2023/0164814 A1
(43) Pub. Date: May 25, 2023

(54) METHOD FOR COMMUNICATION, TERMINAL DEVICE, AND COMPUTER READABLE MEDIA

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 17/918,757

(22) PCT Filed: Apr. 14, 2020
(86) PCT No.: PCT/CN2020/084781

§ 371 Date: Oct. 13, 2022

(51) Int. Cl. H04W 72/40; H04W 74/08

(52) U.S. Cl. CPC H04W 72/40; H04W 74/0808

(57) ABSTRACT

Embodiments of the present disclosure relate to method, devices and computer readable media for communications. A method for communications comprises, determining at a first terminal device, occupancies of resources in a resource pool based on sidelink transmission parameters of the second terminal device, the resource pool comprising resources for a sidelink transmission of a second terminal device. The method further comprises transmitting information about the occupancies of resources to the second terminal device. Embodiments of the present disclosure provide a solution for sidelink resource coordination, and thereby avoiding resource collisions, while improving the reliability and delay of V2X communications.

### FIELD

Embodiments of the present disclosure generally relate to the field of telecommunication, and in particular, to methods, devices, and computer readable medium for communications.

### BACKGROUND

Certain communication systems enable vehicle to everything (V2X) and device to device (D2D) communications to be performed. V2X communications can be based on communication technologies such as sidelink communication technologies. For this end, sidelink resource pools and sidelink channels can be established for vehicles participating in such communications

In V2X communications, there are two sidelink transmission modes each specifying a manner of resource allocation and selection. In a first mode (also referred to as NR V2X mode 1 or mode 1 hereinafter), one terminal device may perform V2X communications with the other terminal device by using resources allocated by a network device, such as a gNode B. In a second mode (also referred to as NR V2X mode 2 or mode 2 hereinafter), terminal devices may perform V2X communications with each other by using resources autonomously selected in a preconfigured resource pool. Since V2X communications are often closely related to road traffic safety and personal security, there is a demand on an enhanced reliability, improved resource coordination and a reduced delay for sidelink communications.

### SUMMARY

In general, example embodiments of the present disclosure provide a solution of resource coordination in V2X communications.

In a first aspect, there is provided a method for communications. The method comprises determining, at a first terminal device, occupancies of resources in a resource pool based on sidelink transmission parameters of the second terminal device, the resource pool comprising resources for a sidelink transmission of a second terminal device. The method further comprises transmitting information about the occupancies of resources to the second terminal device.

In a second aspect, there is provided a method for communications. The method comprises receiving, at a second terminal device from the first terminal device, information about occupancies of resources in a resource pool, the resource pool comprising resources for a sidelink transmission of the second terminal device, the information being based on sidelink transmission parameters of the second terminal device. The method also comprises determining, from the resource pool, a set of resources for the sidelink transmission based on the information.

In a third aspect, there is provided a method for communications. The method comprises determining, at a first terminal device, occupancies of resources in a resource pool based on sidelink transmission parameters of the first terminal device, the resource pool comprising resources for a sidelink transmission of the first terminal device. The method also comprises transmitting, to a second terminal device, information about the occupancies of the resources and the sidelink transmission parameters to assist the second terminal device in selecting resources for a sidelink transmission of the second terminal device.

In a fourth aspect, there is provided a method for communications. The method comprises receiving, at a second terminal device from a first terminal device, information about occupancies of resources in a resource pool and sidelink transmission parameters of the first terminal device, the resource pool comprising resources for a sidelink transmission of the first terminal device, the occupancies of resources being determined based on the sidelink transmission parameters of the first terminal device. The method also comprises determining, from the resource pool, a first set of resources for the sidelink transmission based on the information, the sidelink transmission parameters of the first terminal device and sidelink transmission parameters of the second terminal device.

In an fifth aspect, there is provided a terminal device. The terminal device comprises a processor and a memory storing instructions. The memory and the instructions are configured, with the processor, to cause the terminal device to perform the method according to the first aspect.

In a sixth aspect, there is provided a terminal device. The terminal device comprises a processor and a memory storing instructions. The memory and the instructions are configured, with the processor, to cause the terminal device to perform the method according to the second aspect.

In an seventh aspect, there is provided a terminal device. The terminal device comprises a processor and a memory storing instructions. The memory and the instructions are configured, with the processor, to cause the terminal device to perform the method according to the third aspect.

In an eighth aspect, there is provided a terminal device. The terminal device comprises a processor and a memory storing instructions. The memory and the instructions are configured, with the processor, to cause the terminal device to perform the method according to the fourth aspect.

In a ninth aspect, there is provided a computer readable medium having instructions stored thereon. The instructions, when executed on at least one processor of a device, cause the device to perform the method according to the first aspect.

In a tenth aspect, there is provided a computer readable medium having instructions stored thereon. The instructions, when executed on at least one processor of a device, cause the device to perform the method according to the second aspect.

In an eleventh aspect, there is provided a computer readable medium having instructions stored thereon. The instructions, when executed on at least one processor of a device, cause the device to perform the method according to the third aspect.

In a twelfth aspect, there is provided a computer readable medium having instructions stored thereon. The instructions, when executed on at least one processor of a device, cause the device to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which some embodiments of the present disclosure can be implemented;

FIG. 2 illustrates an example signaling chart showing an example process for resource coordination in accordance with some embodiments of the present disclosure;

FIG. 3 illustrates a flowchart of an example method in accordance with some embodiments of the present disclosure;

FIG. 4 illustrates a schematic diagram of occupancies of resources in a resource pool in accordance with some embodiments of the present disclosure;

FIG. 5 illustrates a flowchart of another example method in accordance with some embodiments of the present disclosure;

FIG. 6 illustrates an example signaling chart showing an example process for resource coordination in accordance with some embodiments of the present disclosure;

FIG. 7 illustrates a flowchart of an example method in accordance with some embodiments of the present disclosure;

FIG. 8A illustrates a schematic diagram of a first determination scheme for determining the occupancies of resources in a resource pool;

FIG. 8B illustrates a schematic diagram of a second determination scheme for determining the occupancies of resources in a resource pool;

FIG. 8C illustrates a schematic diagram of a third determination scheme for determining the occupancies of resources in a resource pool;

FIG. 9 illustrates a flowchart of an example method in accordance with some embodiments of the present disclosure;

FIG. 10 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the term “resource,” “transmission resource,” “resource block,” “physical resource block,” “uplink resource,” or “downlink resource” may refer to any resource for performing a communication, for example, a communication between terminal devices or a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some embodiments of the present disclosure. It is noted that embodiments of the present disclosure are equally applicable to other resources in other domains.

As used herein, the singular forms “a,” “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.”

As used herein, the terms “first”, “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As described above, terminal devices in the mode 2 may perform V2X communications with each other by using resources autonomously selected in a resource pool preconfigured by a network device. Since communication reliability and time delay are key factors for V2X communications, a terminal device needs to determine available resources in the resource pool before performing any communication. Typically, the terminal device may sense sidelink channels in a sensing window to obtain sidelink control information (SCI) and sidelink measurements, for example, the layer 1 reference signal received power (also referred to L1 RSRP) from other terminal devices in proximity to the terminal device. Such a result of sensing indicates occupancies of resources in the resource pool by other terminal devices in the V2X communication system.

In V2X communications, the inter-terminal device coordination may be implemented among a plurality of terminal devices. Particularly, one terminal device may sense the sidelink channels by using its own transmission parameters, such as, the L1 priority, an available packet delay budget, a number of subchannels to be used for the sidelink transmission in a slot, a resource reservation interval, a bandwidth part index associated with the resource pool, and so on, to exclude occupied resources in the resource pool. The one terminal device may then determine and indicate a set of unoccupied resources to another terminal device for selecting resources for V2X communications of the other terminal device. However, the result of sensing may be inaccurate in a case that the two terminal devices differ in sidelink transmission parameters. As a result, the set of candidate resources determined based on the transmission parameters of the one terminal device may be not suitable for the sidelink transmission of the other terminal device.

Embodiments of the present disclosure provide a solution for resource coordination in V2X communications, so as to solve the above problems and one or more of other potential problems. According to the solution, a first terminal device determines occupancies of resources in a resource pool based on sidelink transmission parameters of a second terminal device, the resource pool comprising resources for a sidelink transmission of a second terminal device. The first terminal device transmits information about the occupancies of resources to the second terminal device. Upon receiving the information from the first terminal device, the second terminal device determines, from the resource pool, a set of resources for the sidelink transmission based on the information. In this way, sidelink resource coordination between the first terminal device and the second terminal device is enabled and the resource collisions can be avoided. Moreover, the reliability and delay of V2X communications can be significantly improved.

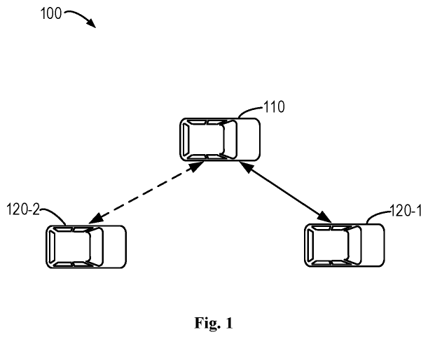

FIG. 1 illustrates a schematic diagram of an example communication network 100 in which embodiments of the present disclosure can be implemented. As shown in FIG. 1, the communication network 100 may include terminal devices 110 (also referred to as “first terminal device 110”), and terminal devices 120-1 and 120-2 (collectively referred to as “second terminal devices 120” or individually referred to as “second terminal device 120”). It should be understood that the communication network 100 may further include a network device (not shown). The network device may communicate with the first terminal device 110 and the second terminal devices 120 via respective wireless communication channels. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

In FIG. 1, the first terminal device 110 and the second terminal devices 120 are shown as vehicles which enable V2X communications. It is to be understood that embodiments of the present disclosure are also applicable to other terminal devices than vehicles, such as mobile phones, sensors and so on.

In some embodiments, the first terminal device 110 may have established a sidelink with the terminal device 120-1. In other words, the first terminal device 110 may have established an on-going communication session with the terminal device 120-1. In this regard, the terminal device 120-1 may be referred to as an in-session terminal device.

In other embodiments, the first terminal device 110 may not have established a sidelink with the terminal device 120-2. In other words, the first terminal device 110 may not have established an on-going communication session with the terminal device 120-1. In this regard, the terminal device 120-1 may be referred to as an out-of-session terminal device.

In order to initiate a resource coordination procedure, the second terminal device 120-1 may transmit a request for scheduling resources for its sidelink transmission to the first terminal device 110. Upon receiving the request, the first terminal device 110 transmits a response, for example an ACK response to the second terminal device 120-1, and a coordination association is established between the first terminal device 110 and the second terminal device. The inter-terminal device coordination may then be initiated.

In the communication network 100, one terminal device may establish coordination associations with more than one other terminal device. In other words, the one terminal device may provide resource coordination with more than one terminal device, or alternatively, the one terminal device may be provided with resource coordination from more than one terminal device.

For example, the first terminal device 110 expects to initiate the resource coordination procedure, and both of second terminal devices 120-1 and 120-2 are capable of providing the resource coordination to the first terminal device 110. In this case, the first terminal device 110 may select one of the second terminal devices 120-1 and 120-2 with the best link quality to establish the coordination association. In a case that there are more than two second terminal devices 120, the first terminal device 110 may select one or more of the second terminal devices 120 with the link qualities above a predetermined threshold to establish the coordination association. The link quality may be a L3 filtered RSRP or reference signal received quality (RSRQ) of physical sidelink control channel (PSCCH), physical sidelink broadcast channel (PSBCH), physical sidelink shared channel (PSSCH), and physical sidelink discovery channel (PSDCH) measured on a PC5 interface.

For another example, the first terminal device 110 may receive requests for scheduling resources from both of second terminal devices 120-1 and 120-2. The first terminal device 110 may select one of the second terminal devices 120-1 and 120-2 with the best link quality or more than one second terminal devices 120 with link qualities above the predetermined threshold to establish the coordination association.

In some embodiments, for example, in a case of the absence of coverage of a cell or a poor communication quality, one of the first terminal device 110 and the second terminal devices 120 may serve as a relay terminal device, and others of the first terminal device 110 and the second terminal devices 120 may serve as remote terminal devices. In a first example, the first terminal device 110 is a relay terminal device, and the second terminal devices 120 are remote terminal devices. In a case that the first terminal device 110 intends for the resource coordination, it may preferably transmit the request for scheduling resources to at least one of its remote terminal device, i.e., the second terminal devices 120-1 and 120-2. In another case that the first terminal device 110 is capable of providing resource coordination, it may receive requests for scheduling resources from other terminal devices including its remote terminal devices, and additionally, it may preferably provide the resource coordination with at least one of the second terminal devices 120-1 and 120-2.

In this example, from the perspective of the second terminal device 120, in a case that the second terminal device 120 intends for resource coordination, it may preferably transmit the request for scheduling resources to its relay terminal device, i.e., the first terminal device 110, with respect to other potential terminal devices capable of providing resource coordination. In another case that the second terminal device 120 is capable of providing the resource condition, it may receive requests for scheduling resources from other terminal devices including its relay terminal device, and additionally, it may preferably provide the resource coordination with the first terminal device 110.

In a second example, the first terminal device 110 is a remote terminal device, and the second terminal device 120 is a relay terminal device. In a case that the first terminal device 110 intends for the resource coordination, it may preferably transmit the request for scheduling resources to its relay terminal device, i.e., the second terminal device 120, with respect to other potential terminal devices capable of providing resource coordination. In another case that the first terminal device 110 is capable of providing resource coordination, it may receive requests for scheduling resources from other terminal devices including its relay terminal device, and additionally, it may preferably provide the resource coordination with the second terminal device 120.

In this example, from the perspective of the second terminal device 120, in a case that the second terminal device 120 intends for resource coordination, it may preferably transmit the request for scheduling resources to its remote terminal devices including the first terminal device 110, with respect to other potential terminal devices capable of providing resource coordination. In another case that the second terminal device 120 is capable of providing the resource condition, it may receive requests for scheduling resources from other terminal devices including its remote terminal device, and additionally, it may preferably provide the resource coordination with the first terminal device 110.

For any of the first terminal device 110 and the second terminal devices 120, the higher layer may trigger the resource sensing procedure and deliver the sidelink transmission parameters to the physical layer. The physical layer may sense the sidelink channel based on the sidelink transmission parameters and return a result of sensing to the higher layer. The higher layer then selects, from the resource pool, resources for the sidelink transmission based on the result of sensing. In a case that sensing is disabled for any of the first terminal device 110 and the second terminal devices 120, resources for a sidelink transmission may be randomly selected from the sidelink resource pool. Alternatively, for example, the second terminal device 120 has no capability of sensing, the first terminal device 110 may sense the sidelink channel for the second terminal device 120.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

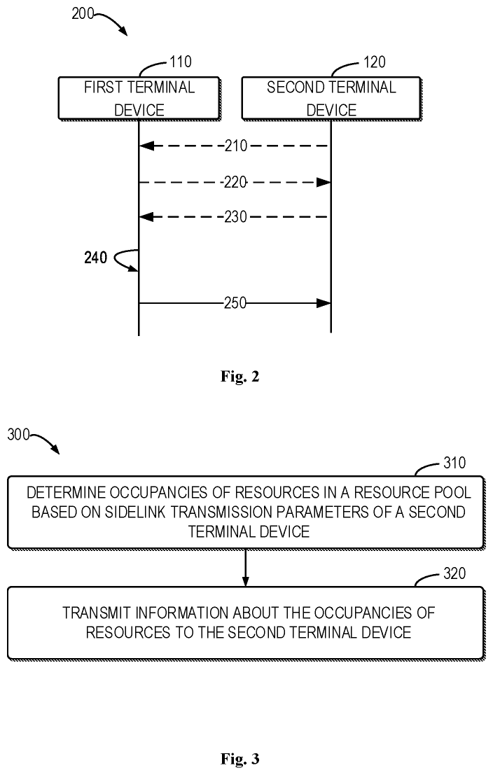

FIG. 2 illustrates an example signaling chart showing an example process 200 for resource coordination in accordance with some embodiments of the present disclosure. As shown in FIG. 2, the process 200 may involve the first terminal device 110 and the second terminal devices 120 as shown in FIG. 1. It is to be understood that the process 200 may include additional acts not shown and/or may omit some acts as shown, and the scope of the present disclosure is not limited in this regard. In addition, it will be appreciated that, although primarily presented herein as being performed serially, at least a portion of the acts of the process 200 may be performed contemporaneously or in a different order than as presented in FIG. 2.

As shown in FIG. 2, in order to establish coordination association, the second terminal device 120 transmits 210 a request for scheduling resources for the sidelink transmission to the first terminal device 110. Upon receipt the request, the first terminal device may transmit 220, for example, an ACK response to the request to the second terminal device 120, and a coordination association between the first terminal device 110 and the second terminal device 120. The first terminal device 110 obtains 230 the sidelink transmission parameters of the second terminal device 120.

The first terminal device 110 may obtain the sidelink transmission parameters of the second terminal device 120 in a plurality of ways. In some embodiments, the sidelink transmission parameters of the second terminal device 120 are preconfigured at the first terminal device 110. In this case, the sidelink transmission parameters are associated with the resource pool predetermined for the sidelink transmission of the second terminal device 120.

In other embodiments, the sidelink transmission parameters of the second terminal device 120 are transmitted from the second terminal device 120 via higher layer signaling, such as PC5 radio resource control (RRC) signaling or a MAC control element. For example, the sidelink transmission parameters may be transmitted together with the request for scheduling resources. In another example, the sidelink transmission parameters may be transmitted after receiving the response to the request by the second terminal device 120.

In order to save the signaling overheads, the second terminal device 120 may transmit a part of the sidelink transmission parameters, for example, a changed part of the sidelink transmission parameters with respect to the sidelink transmission parameters previously transmitted to the first terminal device 110. In this example, upon receipt of the part of the sidelink transmission parameters from the second terminal device 120, the first terminal device 110 updates the stored sidelink transmission parameters to determine the sidelink transmission parameters based on the part of the sidelink transmission parameters and sidelink transmission parameters stored at the first terminal device.

The first terminal device 110 determines 240 the occupancies of resources in the resource pool based on the sidelink transmission parameters of the second terminal device 120. Particularly, in some embodiments, the first terminal device senses the sidelink channel in a sensing window. During the sensing window, the first terminal device 110 obtains at least one of the sidelink control information (SCI) and the sidelink measurements of a terminal device different from the second terminal device 120, for example the first terminal device per se or a third terminal device (not shown). The occupancies of the resources in the resource pool is determined at the first terminal device 110, based on the sidelink transmission parameters of the second terminal device 120.

The first terminal device 110 transmits 250 information about the occupancies of resources to the second terminal device 120. Upon receipt of the information, the second terminal device 120 determines 260, from the resource pool, a set of resources for the sidelink transmission based on the information. The information may be in various forms, which will be discussed in more details below.

In accordance with embodiments of the present disclosure, the set of candidate resources is determined at the first terminal device 110 based on the sidelink transmission parameters of the second terminal device 120, the feasibility of the inter-UE coordination and the accuracy of resource sensing are enhanced.

FIG. 3 illustrates a flowchart of a method 300 for inter-UE coordination in accordance with embodiments of the present disclosure. In some embodiments, the method 300 can be implemented at a terminal device, such as any of the first terminal device 110 and the second terminal device 120 as shown in FIG. 1. Additionally, or alternatively, the method 300 can also be implemented at other terminal devices not shown in FIG. 1. For the purpose of discussion, the method 300 will be described with reference to FIG. 1 as performed by the first terminal device 110 without loss of generality.

At block 310, the first terminal device 110 determines the occupancies of resources in a resource pool based on sidelink transmission parameters of a second terminal device 120. In the V2X communication system, one or more resource pools are preconfigured by a network device for providing resources for sidelink transmissions. The resource pool may be identified by a resource pool index or associated with a bandwidth part index. In some embodiments, the resource pool comprises resources for a sidelink transmission of the second terminal device 120.

At block 320, the first terminal device 110 transmits the information about the occupancies of resources to the second terminal device 120. As mentioned above, such information may be in a plurality of forms. In some embodiments, the information may be in a form of bitmap indicative of the occupancies of resources in the resource pool with a predetermined frequency granularity and a predetermined time granularity. In this example, the frequency granularity of the bitmap is a number of sub-channels to be used for a transmission on at least one of a PSSCH and a PSCCH, the time granularity is a slot or a symbol.

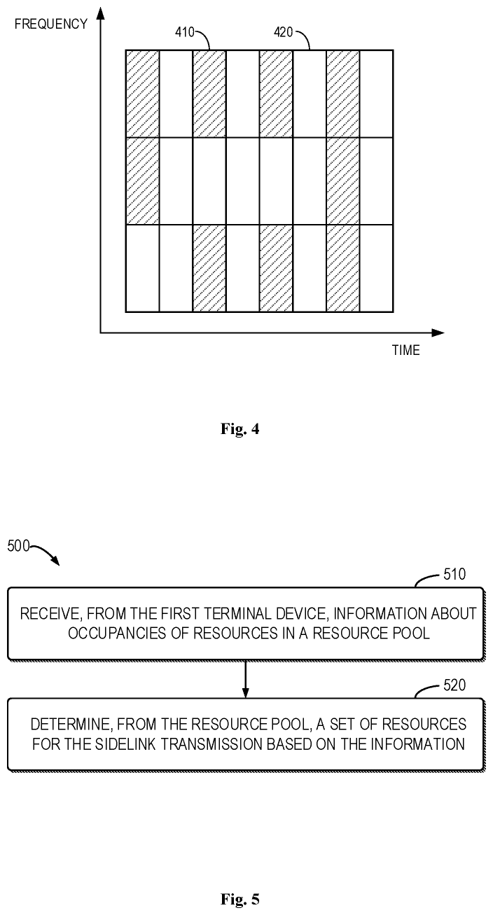

FIG. 4 shows a schematic diagram of the occupancies of resources in the resource pool in accordance with embodiments of the present disclosure. As shown in FIG. 4, the blocks illustrated in slash pattern, for example the block 410, represent occupied time-frequency resources in the resource pool, and the blank blocks, for example the block 420, represent unoccupied time-frequency resources that are available for the sidelink communication of the second terminal device 120. In the embodiments that the information is in a form of bitmap, bit 0 may indicate that a corresponding resource is unoccupied and bit 1 may indicate a corresponding resource is unoccupied, and vice versa. In addition, the length of the bitmap may be defined as, for example, L=T*(B−L__{subCH}+1), T represents the number of slots/symbols in a selection window of the first terminal device 110, B represents the number of subchannel in the resource pool and L__{subCH} represents the number of subchannels to be used for the sidelink transmission. As an example, the bitmap indicative of the occupancies shown in FIG. 4 may be [0011001100110011] or [0101010101010101] with T=8, B=3, L__{subCH}=2.

FIG. 5 illustrates a flowchart of a method 500 for inter-UE coordination in accordance with embodiments of the present disclosure. In some embodiments, the method 500 can be implemented at a terminal device, such as any of the first terminal device 110 and the second terminal device 120 as shown in FIG. 1. Additionally or alternatively, the method 500 can also be implemented at other terminal devices not shown in FIG. 1. For the purpose of discussion, the method 500 will be described with reference to FIG. 1 as performed by the second terminal device 120 without loss of generality.

At block 510, the second terminal device 120 receives, from the first terminal device 110, information about occupancies of resources in the resource pool. The resource pool is configured to provide resources for the sidelink transmission of the second terminal device 120. In this example, the information being based on sidelink transmission parameters of the second terminal device 120.

At block 520, the second terminal device 120 determines, from the resource pool, a set of resources for the sidelink transmission based on the information. Particularly, the second terminal device may unoccupied resources from the resource pool based on the information. For example, in the case of occupancies as shown in FIG. 4, upon decoding the bitmap, the second terminal device 120 may determine that the time-frequency resources illustrated in blank pattern, such as the block 420, are candidate resources for its sidelink transmission. The second terminal device 120 may use all of the unoccupied resources, or alternatively, select a set of resources from the unoccupied resources for performing the sidelink transmission.

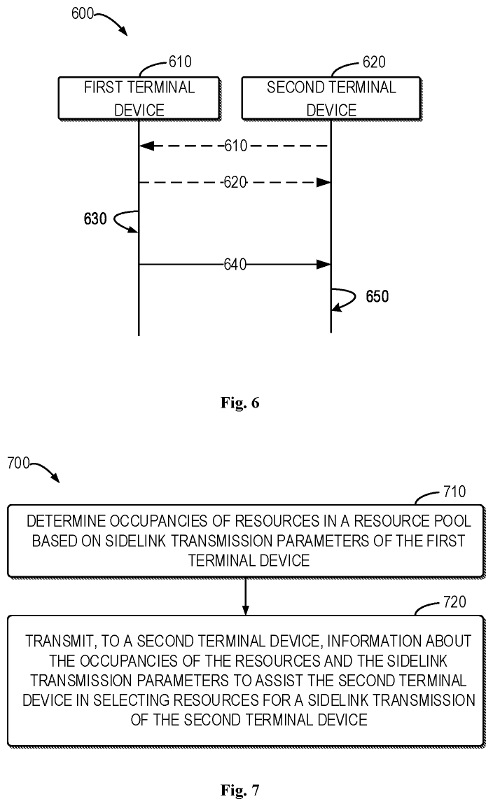

FIG. 6 illustrates an example signaling chart showing another example process 600 for resource coordination in accordance with some embodiments of the present disclosure. As shown in FIG. 6, the process 600 may involve the first terminal device 110 and the second terminal devices 120 as shown in FIG. 1. It is to be understood that the process 600 may include additional acts not shown and/or may omit some acts as shown, and the scope of the present disclosure is not limited in this regard. In addition, it will be appreciated that, although primarily presented herein as being performed serially, at least a portion of the acts of the process 600 may be performed contemporaneously or in a different order than as presented in FIG. 6.

As shown in FIG. 6, in order to establish coordination association, the second terminal device 120 transmits 610 a request for scheduling resources for the sidelink transmission to the first terminal device 110. Upon receipt the request, the first terminal device 110 may transmit 620, for example, an ACK response to the request to the second terminal device 120, and a coordination association between the first terminal device 110 and the second terminal device 120. Steps 610 and 620 are optional steps similar to steps 210 and 220 shown in FIG. 2. For example, in a case that a communication connection or coordination association has already been established between the first terminal device 110 and the second terminal device 120, steps 610 and 620 can be omitted.

The first terminal device 110 determines 630 the occupancies of resources in a resource pool based on sidelink transmission parameters of the first terminal device 110. In this example, the resource pool is configured to provide resources for the sidelink transmission of the first terminal device 110.

Various sidelink transmission parameters can be used in determining the occupancies of resources, including but not limited to the L1 priority, the available packet delay budget, the number of subchannels to be used for the sidelink transmission in a slot, the resource reservation interval, the resource pool index or the bandwidth part index associated with the resource pool, and so on. It is to be understood that the transmission parameters can be varied depending on the environments, communication standards, protocols, requirements, and/or other relevant factors. That is, the sidelink transmission parameters set forth herein is given as examples and the present disclosure is not limited in this aspect.

In order to determine the occupancies of resources, in some embodiments, the first terminal device 110 may sense the sidelink channel, for example, PSCCH or PSSCH, in its sensing window. As described above, during its sensing window, the first terminal device 110 obtains at least one of SCI and the sidelink measurements of a terminal device different from the second terminal device 120, for example the first terminal device per se or a third terminal device (not shown). Unlink the process 200, in this embodiment, the first terminal device 110 then determines the occupancies of the resources in the resource pool based on the sidelink transmission parameters of the first terminal device 110 and the at least one of the sidelink control information and the sidelink measurements.

In other embodiments, for example in cases that the first terminal device may not have the sensing capability or no sidelink transmission parameters are received from the second terminal device 120, or alternatively, in accordance with a configuration from RRC, the first terminal device 110 may determine unoccupied time resources during a time period as a set of resources to be occupied by the first terminal device 110.

The first terminal device 110 transmits 640 the information about the occupancies of resources and the sidelink transmission parameters of the first terminal device 110 to the second terminal device 120 for assisting the second terminal device 120 in selecting resources for its sidelink transmission. The timing for transmitting the sidelink transmission parameters of the first terminal device 110 may be flexible. In some embodiments, the sidelink transmission parameters of the first terminal device 110 may be transmitted together with the information about the occupancies of resources via a higher layer signaling, such as a PC5 RRC signaling, or a MAC control element. In other embodiments, the sidelink transmission parameters of the first terminal device 110 may be transmitted after the information. The present disclosure is not limited in this aspect.

Upon receipt of the information, the second terminal device 120 determines 650, from the resource pool, a set of resources for the sidelink transmission based on based on the information, the sidelink transmission parameters of the first terminal device 110 and sidelink transmission parameters of the second terminal device 120. The details of the determination 650 will be discussed below.

In accordance with embodiments of the present disclosure, the second terminal device 120 has no need to transmit its sidelink transmission parameters to the first terminal device 110 in advance. From the perspective of the first terminal device 110, it does not need to perform an additional sensing process for the second terminal device 120. In addition to the information about the occupancies of resources in the resource pool per se, the sidelink transmission parameters used to determine the information are also provided to the second the second terminal device 120, this enables the second terminal device 120 can first judge whether to take this information into account, and then select resources for its sidelink transmissions accordingly. As such, the resource coordination procedure between the first terminal device 110 and the second terminal device 120 is more feasible and effective, which in turn improves the reliability and reduce the delay of V2X communications.

FIG. 7 a flowchart of a method 700 for inter-UE coordination in accordance with embodiments of the present disclosure. In some embodiments, the method 700 can be implemented at a terminal device, such as any of the first terminal device 110 and the second terminal device 120 as shown in FIG. 1. Additionally, or alternatively, the method 700 can also be implemented at other terminal devices not shown in FIG. 1. For the purpose of discussion, the method 700 will be described with reference to FIG. 1 as performed by the first terminal device 110 without loss of generality.

At block 710, the first terminal device 110 determines the occupancies of resources in a resource pool based on sidelink transmission parameters of the first terminal device 110. The occupancies of resources in a resource pool may be determined in various ways. In some embodiments, the first terminal device 110 may have established a sidelink with the terminal device 120-1. In other words, there is an in-session link, such as unicast link or a groupcast link between the first terminal device 110 and the second terminal device 120. The first terminal device 110 may determine a set of resources to be occupied by its sidelink transmission in a certain time period.

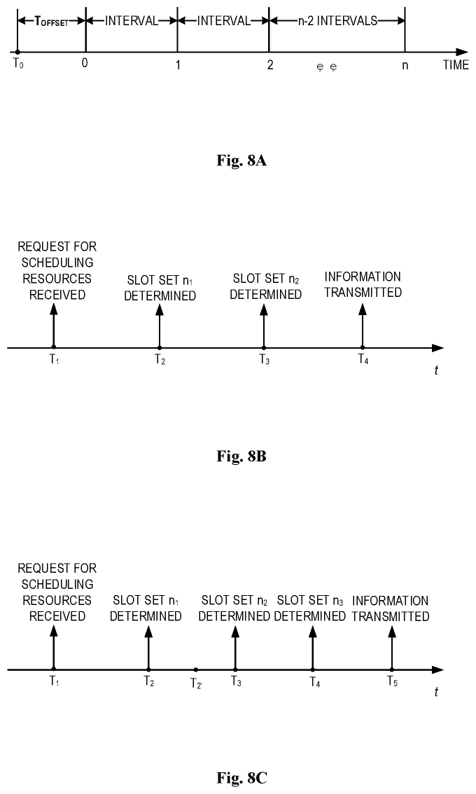

In some embodiments, the sidelink transmission of the first terminal device 110 is performed in a periodic manner and the first terminal device 110 may determine the slots or symbols on which the transmission of the first terminal device 110 will be performed. FIG. 8A shows a schematic diagram of a first determination scheme for determining the occupancies of resources in a resource pool. As shown in FIG. 8A, the first terminal device 110 may transmit slot indices 0, 1 and 2, an interval I₁ and a number of slots or symbols to be occupied by the first terminal device 110 to the second terminal device 120. Alternatively, the first terminal device 110 may transmit the interval I₁ and the number of slots or symbols to be occupied by the first terminal device 110 and an offset T_{offset} to a reference time T₀ indicated by a higher layer signaling to the second terminal device 120.

In other embodiments, the first terminal device 110 may determine a set of slots or symbols on which the transmission of the first terminal device 110 will be performed, or to be reserved in accordance with a first determination scheme. FIG. 8B shows a schematic diagram of a second determination scheme for determining the occupancies of resources in a resource pool. As shown in FIG. 8B, at time point T₁, the first terminal device 110 receives the request for scheduling resources from the second terminal device 120. At time point T₂, the first terminal device 110 determines a first set of slots n₁ is to be reserved, and at time point T₃, the first terminal device 110 determines a second set of slots n₂ is selected for future transmission of the first terminal device 110. The sets of slots n₁ and n₂ may include one or more slots. The determination of the sets n₁ and n₂ may be derived from a higher layer of the first terminal device 110. At time point T₄, the first terminal device 110 transmits the information about the occupancies of resources to the second terminal device 120. The first terminal device 110 may determine the unoccupied time resources during a first time period T₄−T₁ as the set of resources to be occupied, and in this example, the first terminal device 110 may determine all or a part of the selected or reserved resources slots n₁ and n₂ to be the set of resources to be occupied.

In still other embodiments, the first terminal device 110 may determine a set of slots or symbols on which the transmission of the first terminal device 110 will be performed or to be reserved in accordance with a second determination scheme. FIG. 8C shows a schematic diagram of a third determination scheme for determining the occupancies of resources in a resource pool. As shown in FIG. 8C, at time point T₁, the first terminal device 110 receives the request for scheduling resources from the second terminal device 120, at time points T₂ to T₄, the first terminal device 110 respectively determines that sets of slots n₁, n₂ and n₃ are to be reserved or selected for the future transmission of the first terminal device 110, and the first terminal device 110 transmits the information about the occupancies of resources to the second terminal device 120 at time point T₅. In addition, considering at least one of the processing time of the first terminal device 110 and a predetermined time offset (e.g., a time advance offset, frame boundary time offset, etc.) configured via a higher layer signaling, in determining a set of the occupancies of the resource, the first terminal device 110 only takes the indications received during a second period starting from the time point T_{2′} and ending at time point T₅ into consideration. In other words, the first terminal device 110 may omit occupancies of resources determined during a predetermined time duration T_{2′}−T₁, and determine all or a part of the slots included in the sets n₂ and n₃ to be the set of resources to be occupied. The time period between the time point at which the last set of slots is determined and the time point at which the information is transmitted, that is, in this example, the time period T₅−T₄ should be larger than a time period which is configured by a higher layer or associated with the processing time of the first terminal device 110.

In still other embodiments, for example, in the above cases that the first terminal device 110 has no sensing capability, no sidelink transmission parameters are received from the second terminal device 120, or alternatively, in accordance with a configuration via a RRC signaling, the first terminal device 110 may determine the occupancies of resources in a resource pool by determining unoccupied time resources during a time period as a set of resources to be occupied by the first terminal device 110.

At block 720, the first terminal device 110 transmits the information about the occupancies of resources and its sidelink transmission parameters to the second terminal device 120. As mentioned above, such information may be in a plurality of forms. In some embodiments, the information may be in a form of bitmap indicative of the occupancies of resources in the resource pool with a predetermined frequency granularity and a predetermined time granularity, as shown in FIG. 4.

In other embodiments, the first terminal device 110 may transmits the information indicative of the set of resource to be occupied by the sidelink transmission of the first terminal device 110 via a higher layer signaling, such as a PC5 RRC signaling. For example, as shown in 8A, in a case that the sidelink transmission of the first terminal device 110 is performed in a periodic manner, the first terminal device 110 may transmit indices, an interval and a number of slots or symbols to be occupied by the first terminal device 110 to the second terminal device 120. In another example, the first terminal device 110 may transmit an interval and a number of slots or symbols to be occupied by the first terminal device 110 and an offset to a reference time indicated by a higher layer signaling to the second terminal device 120. For the cases as shown in FIGS. 8B and 8C, the first terminal device 110 may transmit slot indices of the slots determined during the first time period T₄−T₁ or alternatively the second time period T₅−T_{2′} as the information indicative of the set of resource.

In order to save the signaling overhead, the first terminal device 110 may transmit a part of the sidelink transmission parameters, for example, a changed part of the sidelink transmission parameters with respect to the sidelink transmission parameters previously transmitted to the second terminal device 120. In this example, upon receipt of the part of the sidelink transmission parameters from the first terminal device 110, the second terminal device 120 updates the stored sidelink transmission parameters to determine the sidelink transmission parameters based on the part of the sidelink transmission parameters and sidelink transmission parameters stored at the second terminal device 120.

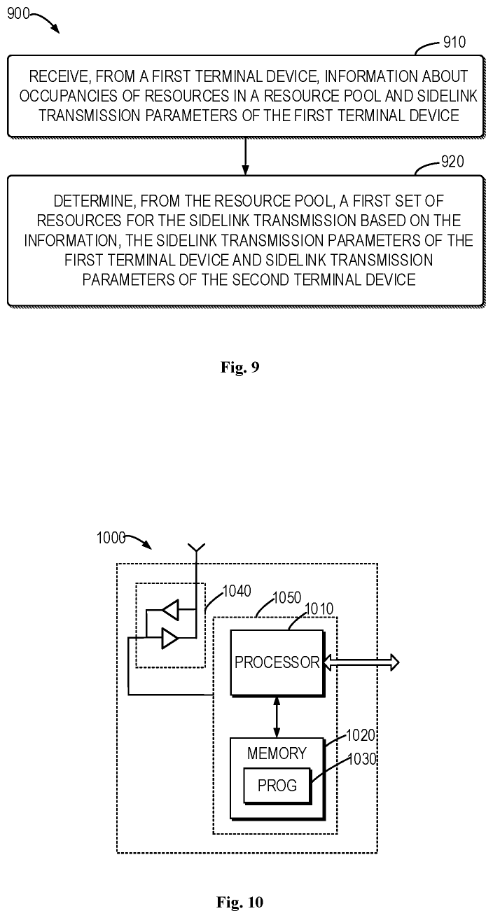

FIG. 9 illustrates a flowchart of a method 900 for inter-UE coordination in accordance with embodiments of the present disclosure. In some embodiments, the method 900 can be implemented at a terminal device, such as any of the first terminal device 110 and the second terminal device 120 as shown in FIG. 1. Additionally or alternatively, the method 900 can also be implemented at other terminal devices not shown in FIG. 1. For the purpose of discussion, the method 900 will be described with reference to FIG. 1 as performed by the second terminal device 120 without loss of generality.

At block 910, the second terminal device 120 receives, from the first terminal device 110, information about occupancies of resources in the resource pool and sidelink transmission parameters of the first terminal device 110. In this example, the resource pool is configured to provide resources for the sidelink transmission of the first terminal device 110. The occupancies of resources are determined based on the sidelink transmission parameters of the first terminal device 110.

As previously discussed, since the timing for transmitted the sidelink transmission parameters of the first terminal device 110 is flexible, the second terminal device 120 may receive the sidelink transmission parameters of the first terminal device 110 together with the information. Alternatively, the second terminal device 120 may receive the sidelink transmission parameters of the first terminal device 110 after the information. The present disclosure is not limited in this aspect.

At block 920, the second terminal device 120 determines, from the resource pool, a first set of resources for the sidelink transmission of the second terminal device 120 based on the information, the sidelink transmission parameters of the first terminal device 110 and the sidelink transmission parameters of the second terminal device 120. As described above, the information may be in various forms. For example, the information may be a bitmap as described in connection with FIG. 4 and therefore it will not be repeated herein.

Alternatively, the information may indicate a second set of resources to be occupied by the sidelink transmission of the first terminal device 110. In this embodiment, the information indicates the unoccupied time resources during a time period as the second set of resources, as described above in connection with FIG. 8 and therefore it will not be repeated herein.

In order to determine the first set of resources for the sidelink transmission of the second terminal device 120, in some embodiments, the second terminal device 120 may further compare the sidelink transmission parameters of the first terminal device 110 and the sidelink transmission parameters of the second terminal device 120 based on a predetermined rule. The predetermined rules may be associated with at least one of the sidelink transmission parameters, including but not limited to the L1 priority, the available packet delay budget, the number of subchannels to be used for the sidelink transmission in a slot, the resource reservation interval, the resource pool index, a resource pool index, the bandwidth part index associated with the resource pool and so on.

Particularly, in a case that the sidelink transmission parameters of the first terminal device 110 and the sidelink transmission parameters of the second terminal device 120 meet the predetermined rule, the second terminal device 120 may determines the unoccupied resources from the resource pool based on the information about the occupancies of the resources. In an embodiment, the predetermined rule may be met in a case that the L1 priority of the first terminal device 110 is lower than or equal to the L1 priority of the second terminal device 120. For example, the first terminal device 110 has a L1 priority of 6, while the second terminal device 120 has a L1 priority of 2 to be transmitted in its associated SCI, in this case, a terminal device with a relatively high priority, i.e., the second terminal device 120 may take the information determined based on the sidelink transmission parameters of another terminal device with a relatively low priority, i.e., the first terminal device 110, into account, and the resource coordination procedure is feasible.

For another example, the predetermined rule may be met in a case that the number of subchannels to be used for the sidelink transmission in a slot of the first terminal device 110 is larger than or equal to the number of subchannels to be used for the sidelink transmission in a slot of the second terminal device 120. For still another example, the predetermined rule may be met in a case that an available packet delay budget of the first terminal device 110 is larger than or equal to an available packet delay budget of the second terminal device 120. In yet another example, the predetermined rule may be met in a case that at least one of the resource reservation interval, the resource pool index of the resource pool and the bandwidth part index associated with the resource pool of the first terminal device 110 is the same as a corresponding one of the second terminal device 120.

On the other hand, in a case that the sidelink transmission parameters of the first terminal device 110 and the sidelink transmission parameters of the second terminal device 120 do not meet the predetermined rule, the second terminal device 120 may drop the information.

By means of information about the occupancies of resources in a resource pool, the embodiments of the present disclosure provide a way of explicitly or implicitly indicating the candidate resources in the resource pool. Moreover, since the transmission parameters with which the information is determined are also provided to the second terminal device, the solution of the present disclosure can assist the second terminal device 120 in judging whether the information has value of reference in selecting resources. All kinds of terminal devices varying from device complexities, hardware structures, service requirements, and so on can benefit from the resource coordination solution.

FIG. 10 is a simplified block diagram of a device 1000 that is suitable for implementing some embodiments of the present disclosure. The device 1000 can be considered as a further example embodiment of the first terminal device 110 and the second terminal device 120 as shown in FIG. 1. Accordingly, the device 1000 can be implemented at or as at least a part of the first terminal device 110 and the second terminal device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1020 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1030 is assumed to include program instructions that, when executed by the associated processor 1010, enable the device 1000 to operate in accordance with the embodiments of the present disclosure, as discussed herein with reference to any of FIGS. 3, 5, 7 and 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In some embodiments, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 7-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communications, comprising:
determining, at a first terminal device, occupancies of resources in a resource pool based on sidelink transmission parameters of a second terminal device, the resource pool comprising resources for a sidelink transmission of the second terminal device; and
transmitting information about the occupancies of resources to the second terminal device.

2. The method of claim 1, further comprising:
receiving, from the second terminal device, a request for scheduling resources for the sidelink transmission; and
obtaining the sidelink transmission parameters of the second terminal device.

3. The method of claim 2, wherein obtaining the sidelink transmission parameters of the second terminal device comprises:
obtaining the sidelink transmission parameters preconfigured at the first terminal device, the sidelink transmission parameters being associated with the resource pool.

4. The method of claim 2, wherein obtaining the sidelink transmission parameters comprises:
obtaining the sidelink transmission parameters from the request.

5. The method of claim 2, wherein obtaining the sidelink transmission parameters of the second terminal device comprises:
transmitting a response to the request to the second terminal device; and
receiving the sidelink transmission parameters from the second terminal device.

6. The method of claim 2, wherein obtaining the sidelink transmission parameters of the second terminal device comprises:
receiving a part of the sidelink transmission parameters from the second terminal device; and
determining the sidelink transmission parameters based on the part of the sidelink transmission parameters and sidelink transmission parameters stored at the first terminal device.

7. The method of claim 2, wherein obtaining the sidelink transmission parameters of the second terminal device comprises:
obtaining, from the second terminal device, the sidelink transmission parameters of the second terminal device via a radio resource control signaling or a MAC control element.

8. The method of claim 1, wherein determining the occupancies of the resources in the resource pool comprises:
sensing a sidelink channel in a sensing window;
obtaining, from a result of the sensing, at least one of sidelink control information and sidelink measurements of a terminal device different from the second terminal device; and
determining the occupancies of the resources in the resource pool based on the sidelink transmission parameters and the at least one of the sidelink control information and the sidelink measurements.

9. The method of claim 1, wherein transmitting the information about the occupancies of the resources in the resource pool comprises:
transmitting a bitmap indicative of the occupancies of resources in the resource pool with a predetermined frequency granularity and a predetermined time granularity.

10. The method of claim 9, wherein the predetermined frequency granularity is a number of sub-channels to be used for a transmission on at least one of a physical sidelink shared channel (PSSCH) and a physical sidelink control channel (PSCCH) and the predetermined time granularity is a slot or a symbol.

11. The method of claim 1, wherein the sidelink transmission parameters of the second terminal device comprise at least one of a layer 1 priority, an available packet delay budget, a number of subchannels to be used for the sidelink transmission in a slot, a resource reservation interval, and a bandwidth part index associated with the resource pool.

12. The method of claim 1, wherein one of the first terminal device and the second terminal device is a relay terminal device and the other of the first terminal device and the second terminal device is a remote terminal device.

13. A method for communications, comprising:
receiving, at a second terminal device from a first terminal device, information about occupancies of resources in a resource pool, the resource pool comprising resources for a sidelink transmission of the second terminal device, the information being based on sidelink transmission parameters of the second terminal device; and
determining, from the resource pool, a set of resources for the sidelink transmission based on the information.

14. The method of claim 13, further comprising:
transmitting a request for scheduling resources for the sidelink transmission to the first terminal device; and
receiving a response to the request from the first terminal device.

15. The method of claim 14, further comprising:
transmitting the sidelink transmission parameters in the request for scheduling resources.

16. The method of claim 14, further comprising:
transmitting the sidelink transmission parameters to the first terminal device after receiving the response to the request.

17. The method of claim 15 or 16, further comprising determining wherein transmitting the sidelink transmission parameters comprises:
transmitting a part of sidelink transmission parameters with respect to sidelink transmission parameters stored at the first terminal device.

18. The method of claim 15 or 16, wherein transmitting the sidelink transmission parameters comprises:
transmitting the sidelink transmission parameters to the first terminal device via a radio resource control signaling or a MAC control element.

19. The method of claim 13, wherein determining a set of resources for the sidelink transmission based on the information comprises:
determining unoccupied resources from the resource pool based on the information; and
selecting, from the unoccupied resources, a set of resources for the sidelink transmission.

20. The method of claim 13, wherein receiving the information about the occupancies of the resources comprises:
receiving a bitmap indicative of the occupancies of resources in the resource pool with a frequency granularity and a predetermined time granularity.

21. The method of claim 20, wherein the predetermined frequency granularity is a number of sub-channels to be used for a transmission on at least one of a physical sidelink shared channel (PSSCH) and a physical sidelink control channel (PSCCH) and the predetermined time granularity is a slot or a symbol.

22. The method of claim 13, wherein the sidelink transmission parameters of the second terminal device comprise at least one of a layer 1 priority, an available packet delay budget, a number of subchannels to be used for the sidelink transmission in a slot, a resource reservation interval, and a bandwidth part index associated with the resource pool.

23. The method of claim 13, wherein one of the first terminal device and the second terminal device is a relay terminal device and the other of the first terminal device and the second terminal device is a remote terminal device.

24. A method for communications, comprising:
determining, at a first terminal device, occupancies of resources in a resource pool based on sidelink transmission parameters of the first terminal device, the resource pool comprising resources for a sidelink transmission of the first terminal device; and
transmitting, to a second terminal device, information about the occupancies of the resources and the sidelink transmission parameters to assist the second terminal device in selecting resources for a sidelink transmission of the second terminal device.

25. The method of claim 24, wherein determining the occupancies of the resources in the resource pool comprises:
in response to receiving, from the second terminal device, a request for scheduling resources for the sidelink transmission of the second terminal device, transmitting a response to the request to the second terminal device; and
determining the occupancies of the resources in the resource pool.

26. The method of claim 24, wherein determining the occupancies of the resources in the resource pool comprises:
sensing a sidelink channel in a sensing window;
obtaining, from a result of sensing, at least one of sidelink control information and sidelink measurements of a terminal device different from the second terminal device; and
determining the occupancies of the resources in the resource pool based on the sidelink transmission parameters and the at least one of the sidelink control information and the sidelink measurements.

27. The method of claim 25, wherein determining the occupancies of the resources in the resource pool comprises:
determining a set of resources to be occupied by the first terminal device.

28. The method of claim 27, wherein determining the set of resources to be occupied by the first terminal device comprises:
determining unoccupied time resources during a time period as the set of resources to be occupied, the time period starting from a time point when the request is received and being associated with at least one of a predetermined time duration, a predetermined time offset, and a processing time of the first terminal device.

29. The method of claim 27, wherein determining the set of time resources to be occupied by the first terminal device comprises:
determining unoccupied time resources during a time period as the set of resources to be occupied, the time period starting from a first time point when the request is received to a second time point when the information is transmitted.

30. The method of claim 27, wherein transmitting the information about the occupancies of the resources in the resource pool comprises:
transmitting information indicative of the set of resources.

31. The method of claim 27, wherein the sidelink transmission of the first terminal device is performed in a periodic manner, and wherein transmitting the information indicative of the set of resources comprises:
transmitting indices, an interval and a number of slots or symbols to be occupied by the first terminal device; or
transmitting an interval and a number of slots or symbols to be occupied by the first terminal device and an offset to a reference time, the reference time being indicated by a higher layer signaling.

32. The method of claim 24, wherein transmitting the information about the occupancies of the resources in the resource pool comprises:
transmitting a bitmap indicative of the occupancies of resources in the resource pool with a frequency granularity and a predetermined time granularity.

33. The method of claim 24, wherein the frequency granularity is a number of sub-channels to be used for a transmission on at least one of a physical sidelink shared channel (PSSCH) and a physical sidelink control channel (PSCCH) and the predetermined time granularity is a slot or symbol.

34. The method of claim 24, wherein transmitting the information about occupancies of resources and the sidelink transmission parameters comprises:
transmitting the information about the occupancies of the resources together with the sidelink transmission parameters; or
transmitting the sidelink transmission parameters after the information about the occupancies of the resources.

35. The method of claim 24, wherein transmitting the sidelink transmission parameters comprises:
transmitting a part of sidelink transmission parameters with respect to sidelink transmission parameters stored at the second terminal device.

36. The method of claim 24, wherein transmitting the sidelink transmission parameters comprises:
transmitting the sidelink transmission parameters via a radio resource control signaling or a MAC control element.

37. The method of claim 24, wherein the sidelink transmission parameters of the first terminal device comprise at least one of a layer 1 priority, an available packet delay budget, a number of subchannels to be used for the sidelink transmission in a slot, a resource reservation interval, a resource pool index and a bandwidth part index associated with the resource pool.

38. The method of claim 24, wherein one of the first terminal device and the second terminal device is a relay terminal device and the other terminal device is a remote terminal device.

39. A method for communications, comprising:
receiving, at a second terminal device from a first terminal device, information about occupancies of resources in a resource pool and sidelink transmission parameters of the first terminal device, the resource pool comprising resources for a sidelink transmission of the first terminal device, the occupancies of resources being determined based on the sidelink transmission parameters of the first terminal device; and
determining, from the resource pool, a first set of resources for the sidelink transmission based on the information, the sidelink transmission parameters of the first terminal device and sidelink transmission parameters of the second terminal device.

40. The method of claim 39, wherein receiving the information about the occupancies of the resources comprises:
transmitting a request for scheduling resources for the sidelink transmission to the first terminal device; and
receiving the information about the occupancies of the resources after receiving a response to the request from the first terminal device.

41. The method of claim 39, wherein receiving the information about the occupancies of the resources and the sidelink transmission parameters of the first terminal device comprises:
receiving the information about the occupancies of the resources together with the sidelink transmission parameters of the first terminal device; or
receiving the sidelink transmission parameters of the first terminal device after the information about the occupancies of the resources.

42. The method of claim 40, wherein receiving information about the occupancies of the resources in the resource pool comprises:
receiving information indicative of a second set of resources to be occupied by the sidelink transmission of the first terminal device.

43. The method of claim 42, wherein receiving the information indicative of the second set of resources comprises:
receiving the information indicative of unoccupied time resources during a time period as the second set of resources, the time period starting from a first time point when the request is received and being associated with at least one of a predetermined time duration, a predetermined time offset, and a processing time of the first terminal device.

44. The method of claim 42, wherein receiving the information indicative of the second set of resources comprises:
receiving the information indicative of unoccupied time resources during a time period to be the second set of resources, the time period starting from a first time point when the request is received to a second time point when the information is transmitted by the first terminal device.

45. The method of claim 42, wherein the sidelink transmission of the first terminal device is performed in a periodic manner, and wherein receiving the information indicative of the second set of resources comprises:
receiving indices, an interval and a number of slots or symbols to be occupied by the first terminal device; or
receiving an interval and a number of slots or symbols to be occupied by the first terminal device and an offset to a reference time, the reference time being indicated by a higher layer signaling.

46. The method of claim 39, wherein receiving the information about the occupancies of the resources comprises:
receiving a bitmap indicative of the occupancies of resources in the resource pool with a frequency granularity and a predetermined time granularity.

47. The method of claim 46, wherein the frequency granularity is a number of sub-channels to be used for a transmission on at least one of a physical sidelink shared channel (PSSCH) and a physical sidelink control channel (PSCCH) and the predetermined time granularity is a slot or symbol.

48. The method of claim 39, wherein receiving the information about the occupancies of the resources and the sidelink transmission parameters of the first terminal device comprises comprising:
receiving the information and the sidelink transmission parameters of the first terminal device comprises via a radio resource control signaling or a MAC control element.

49. The method of claim 39, wherein determining a first set of resources for the sidelink transmission comprises:
in accordance with a determination of the sidelink transmission parameters of the first terminal device and the sidelink transmission parameters of the second terminal device meeting a predetermined rule, determining unoccupied resources from the resource pool based on the information about the occupancies of the resources; and
selecting the first set of resources for the sidelink transmission from the unoccupied resources.

50. The method of claim 49, further comprising:
determining that the sidelink transmission parameters of the first terminal device and the sidelink transmission parameters of the second terminal device meets the predetermined rule in response to at least one of the following:
a layer 1 priority of the first terminal device is lower than or equal to a layer 1 priority of the second terminal device;
a number of subchannels to be used for the sidelink transmission in a slot of the first terminal device is larger than or equal to a number of subchannels to be used for the sidelink transmission in a slot of the second terminal device;
an available packet delay budget of the first terminal device is larger than or equal to an available packet delay budget of the second terminal device;
a resource reservation interval of the first terminal device is the same as a resource reservation interval of the second terminal device;
a resource pool index of the resource pool for the first terminal device is the same as a resource pool index of a resource pool for the second terminal device; and
a bandwidth part index associated with the resource pool of the first terminal device is the same as a bandwidth part index associated with a resource pool of the second terminal device.

51. The method of claim 39, wherein the sidelink transmission parameters of the first terminal device and the second terminal device comprise at least one of a layer 1 priority, an available packet delay budget, a number of subchannels to be used for the sidelink transmission in a slot, a resource reservation interval, a resource pool index, and a bandwidth part index associated with the resource pool.

52. The method of claim 39, wherein one of the first terminal device and the second terminal device is a relay terminal device and the other one of the first terminal device and the second terminal device is a remote terminal device.

53. A terminal device, comprising:
a processor; and
a memory coupled to the processor and storing instructions thereon, the instructions, when executed by the processor, causing the terminal device to perform the method according to any of claims 1-12.

54. A terminal device, comprising:
a processor; and
a memory coupled to the processor and storing instructions thereon, the instructions, when executed by the processor, causing the terminal device to perform the method according to any of claims 13-23.

55. A terminal device, comprising:
a processor; and
a memory coupled to the processor and storing instructions thereon, the instructions, when executed by the processor, causing the terminal device to perform the method according to any of claims 24-38.

56. A terminal device, comprising:
a processor; and
a memory coupled to the processor and storing instructions thereon, the instructions, when executed by the processor, causing the terminal device to perform the method according to any of claims 39-52.

57. A computer readable medium having instructions stored thereon, the instructions, when executed on at least one processor of a device, causing the device to carry out the method according to any of claims 1-12.

58. A computer readable medium having instructions stored thereon, the instructions, when executed on at least one processor of a device, causing the device to carry out the method according to any of claims 13-23.

59. A computer readable medium having instructions stored thereon, the instructions, when executed on at least one processor of a device, causing the device to carry out the method according to any of claims 24-38.

60. A computer readable medium having instructions stored thereon, the instructions, when executed on at least one processor of a device, causing the device to carry out the method according to any of claims 39-52.
